(19) United States
(12) Patent Application Publication
(10) Pub. No.: US 2002/0196557 A1
(43) Pub. Date: Dec. 26, 2002

(54) Adjustable (controllable) focus lens

(76) Inventor: Chung Kuang Chen, Atlanta, GA (US)

Correspondence Address: Chung K. Chen, Apt. # K-12, 2628 NE Expressway, Atlanta, GA, 30345, US

(21) Appl. No.: 09/871,938

(22) Filed: Jun. 4, 2001

(51) Int. Cl. G02B 1/06; G02B 3/12

(52) U.S. Cl. 359/665; 359/642

(57) ABSTRACT

The conventional optical lens is made of rigid materials. The focus of such lens is determined and can not be changed after it is grind and finished. Now, my invention is to create a kind of lens that its focus can be easily changed and adjustable.

### BACKGROUND OF INVENTION

I want to fully explain the following points:

A. What existed before my invention

B. What the problems are of the pre-existing art

C. What the benefits are of my invention

D. Why is my invention so good

A. What Existed Before My Invention

Before my invention all optical lens, mirror and glasses are presently made of rigid materials (plastics and glass). Each of these materials is made with a specific optical focus in mind. An example is the popular conventional lens presently being used in eyeglasses. Eyes glass lens has to be individually grinded to fit ones eyes. Large lens such as those used in astronomy telescopes requires a manufacturing process that is very time consuming and can be very expensive. The process of one-lens-one focus has been applied in the creation of many rigid optical lenses-from eyeglasses, camera lens, to telescope lens.

The difficulty, inconvenience, and expense involved in creating each lens for specific focus has propelled me to create a new kind of optical lens, where about its focus can be conveniently adjustable at anytime based on the needs of the individual. This one-lens-fits-all approach that I have designed will reduce the time and cost associated with creating optical lens.

B. What the Problems are of the Pre-Existing Art

As I have mentioned above, the main problems are that the mediums are rigid, have to be grinded, one specific focus (which is not changed until it is created). The production process is very time consuming, especially for large optical lens such as astronomical telescope lens. If an error occurs somewhere in the lens production as it is presently being done, the whole process has to be started over from scratch—the whole lens has to be disposed of and the process of grinding a new lens has to be repeated—making this process costly. The process of designing an astrophysical optical lens as is presently being done, sometimes takes at least ten years a unit—another popular application of telescopes being used by people. At this time they are inconveniently heavy, not easy to control, takes two hands to hold the unit in order to adjust the focus lens.

C. What the Benefits are of My Invention

The main advantage of my invention is that no rigid materials have been used. No grinding process is needed. I use soft transparent materials and a liquid substance, which has approximately the same refraction index as glass (˜1.5), such as PVC and silicon oil. Much different kind of materials has such properties. Any kind of optical lens, such as eyeglasses can be created with my process. To change the focus of my lens is quite simple and easy to accomplish. This item can be mass-produced. Suitable eye glasses can be obtained over the counter—it will not be necessary to go thru the step of going to see the eye doctor for an eye examination and then having to wait for the glasses to be made later. If my invention is used everyone can go to the store, choose a lens, change the focus to fit the site, and purchase the lens—that's all! This process is not just for eyeglasses—it can be used at astronomical observational facilities in designing large focus lens. This process can also be used for cameras, military telescopes, magnifying glasses, and projectors. This lens can also be used in industrial and energy fields such as computers, cars, and solar energy industries. All focus lenses can be manufactured by using soft transparent focus procedures.

D. Why is My Invention So Good

1. Easy to manufacture, no rigid materials needed, no grinding process needed.

2. Inexpensive

3. Quick timing process

4. Lighter weight than the rigid lens

5. This new lens can be used at the space shuttle—like the Hubble Space Telescope

6. Less cost if this lens is used in designing cameras, TV screen supplement, the car industry, and many other fields.

7. Solar energy used this soft lens instead of using reflection mirrors-clean, soft lens will be much easier than clean, traditional reflection mirror.

8. There can be an abundance of creations that would adhere to this new type of lens. I mentioned the car industry previously. Example: If the driver is near sighted or farsighted, the front glass for the automobile can be designed for sight if so desired. This same process can be used in designing computers.

As a whole, my invention can cut production cost for products, save time; manufacturing can be simple, and most important this lens is a changeable focus lens. I truly believe that there is a demand for my invention in today's market.

### SUMMARY OF INVENTION

This invention is to create a kind of lens that its focus can be changed. The focus of all optical lens is determined by the curvature of the lens*. The conventional optical lens is made of the rigid material (plastics or glasses). The focus lens is determined and cannot be easily changed after it is grinded and finished.

This invention is to create a lens with transparent and flexible materials such as PVC, etc., instead of rigid ones. Two layers of such material with some space between the layers can combine this lens. This space is then to be filled with transparent liquid (refraction index ˜1.5, or silicon oil), which is pushed between the layers with a small pump attached to the glass frame leg. By controlling the pump pressure we can change the hydraulic pressure on the inside of the lens, we can then control the curvature of the lens in a measurable manner. The focus of the lens changes with its curvature (see the lens maker's equation)*

| | |
|---|---|
| 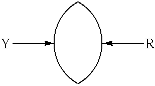 | The focus of the lens can be obtained by the lens maker's equation: 1/f = (n − 1)(1/r − 1/R) f is the focus n is refraction index r, R, are the radius of curvatures of the front surface and the back surface of the lens. |

Any size of this kind of adjustable lens can be made easily. They can be put in front of the driver in a car to let the driver see clearly. They can also be put in front of the TV screen to enlarge the image. Instead of people using two solid mirrors that are combined together, the side-car mirror surface can be made in different curvatures radii in the same mirror, which gives the driver more angles for viewing. In industry meter size concave lens are used to concentrate the energy from sunlight to get very high temperatures ˜10³° C. This cheaper device, which is easy to make, can be used for domestic solar applications in third world countries.

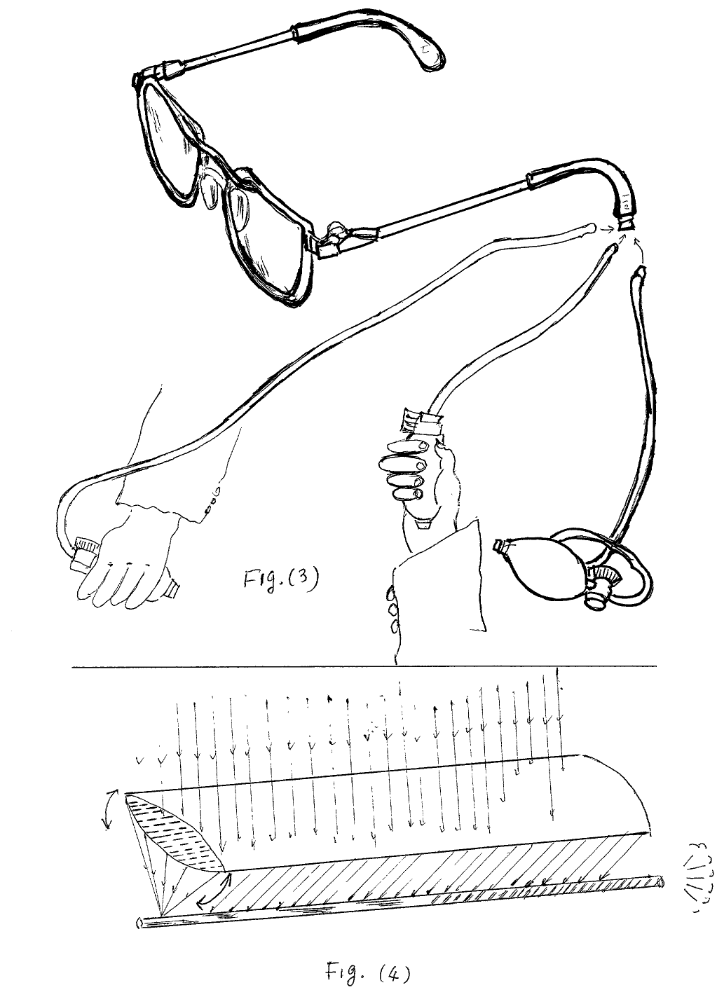

In this solar energy system, water and rigid glass can be used in place of expensive liquids and soft flexible materials. If we produce electrical power, longer lens segments connected to let the sunlight concentrate to the central black coating metal tube. (See FIG. 4) Solar energy produces high temperatures in the tube, which changes the water inside the tube to steam. This steam propels the generator to produce electricity. If the longer lens system can rotate around the central tube as an axis, the concentration of sunlight will remain consistent in the tube, which gives high power of electricity. Soft adjustable focus lens has a variety of applications. If more than one lens are used, we can combine them to be used in cameras, telescopes, video cameras, and cinema cameras, which will be much lighter to carry. Under this soft lens invention there are many new applications worth exploring.

### BRIEF DESCRIPTION OF DRAWINGS

### for adjustable contrallable focus lens

FIG. (0-1) Before the lens changed, the lens as indicated by (ABCDEFA), (t) is thr thin tube used for injecting liquid. After the lens changed the lens as indicated by (ABCDEFA), that means that concave lens focus is changed.

FIG. (0-2) Before and after the convex lens changed ,the lens indicated by (ABCDEFA) and (ABCDEFA) respectively. (t) is the thin tube which is used for injecting air.

FIG. (1) and FIG. (2) are examples of my invintion that applies to the concave or convex lens and how the focus of the lens is changed. We can see the concave lens thickness is increasing but for the convex lens thickness is decreasing, even the soft transparent material for both of them are decreasing from L to 1.

FIG. (3) is an example of the application to the adjustable focus lens: eye glasses. This figure is overall view of the eye glasses using this invention. FIG. (3) indicate the correlation between the flexiblable lens with the liquid or. air pump, and how they work together to achieve the goal of changing the focus of lens.

### DETAILED DESCRIPTION OF DRAWINGS

FIG. (1) is an example of the invention applies to the concave lens and how the focus of the lens is changed. The outmost layer (A OBO′A) is a rigid transparent uniform thickness layer, which protect the soft flexible transparent lens, that has refraction index n˜1.5. If PMMA contact lens material is used, it has n=1.46-1.52. This soft material like a football shape which is surrounded by two surfaces (C1D1AC) and (A2B2′A.) These two surfaces make the football surface thickness not uniform, at the central part thickness is thinner and apart from central portion the thickness is increasing At the middle of the football, there is a space which will be filled with a kind of a transparent liquid, it has refraction index n˜1.5 too , such as silicon oil. If we pump more liquid through a thin tube (t) into this space , the inside of this football pressure is increasing. Because the football surface thickness is not uniform, so the thinner thickness surface will expand more than the thicker one. This changed the curvature radius of the surface then changed the focus f

focus f follows the equation

f=rR/(n−1)(R−r)

R,r are front and back surface curvature of radii . FIG. (2) is an example of the invention applies the convex lens and how the focus of the lens is changed. As FIG. (1) above we mentioned, when the space pressure is increasing the soft transparent flexible material changed the surface curvature of radius that means that focus is changed. FIG. (1) and FIG. (2) have two differences, (I) for concave lens filled with silicon oil, for convex lens filled with air, both of them increasing the pressure. (II) for concave lens the lens shape like a football( [symbol] , [symbol] ). But for convex lens the shape is like a cake ( [symbol] ).

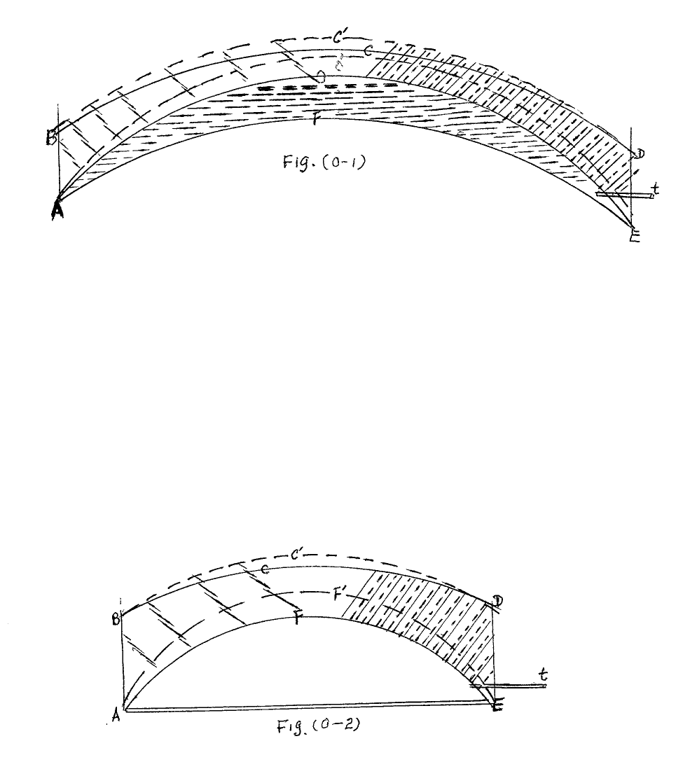

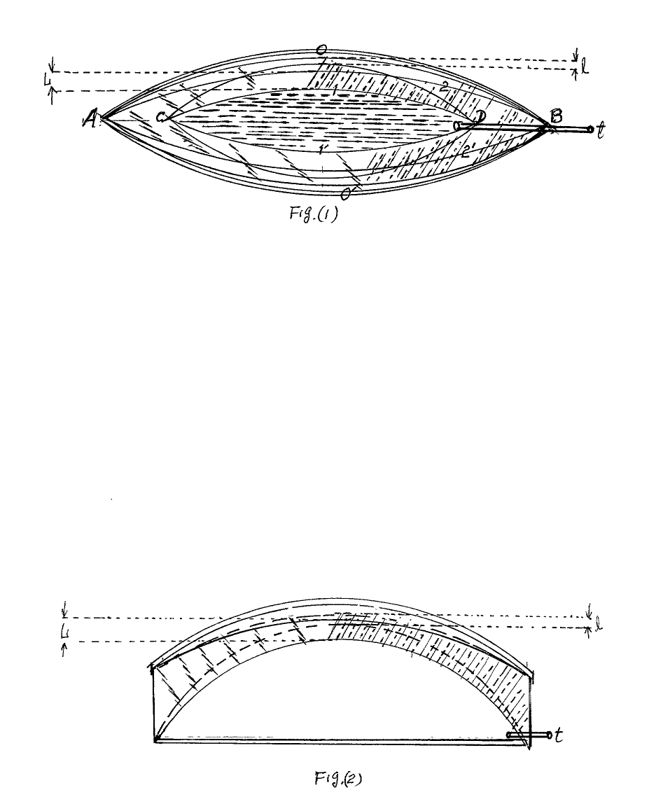

FIG. 3 is an overall view of eyeglass using this invention to convex or concave lens. As mentioned above for concave lens, liquid is injected, for convex lens only air is injected , all of these methods make the lens curvature of radius changing. The small pump can be installed into the end of glasses leg, or can be connected a liquid inflation bulb or an air inflation bulb. Let people easily control in anytime, example for seniors when they walk, it like a regular glasses, when they are reading it becomes reading glasses, just use hand (either right or left hand) to press the inflation bulb, that is all.

What I claim as my invention are:

1) The adjustable optical focus lens.
To change rigid lens which one lens only has one focus into an adjustable (controllable) focus lens, at an easier way to control the pressure which changed the curvature radius of the lens surface to achieve the goal of changing focus of the lens.

2) As a whole all of the optical lenses (fixed focus) can be changed to adjustable focus lenses by using this invention.

3) It can be set up a program for a computer to control the focus changing automatically according our research needed.
